(19) United States
(12) Patent Application Publication
(10) Pub. No.: US 2015/0061613 A1
(43) Pub. Date: Mar. 5, 2015

(54) DC-DC CONVERTER AND METHOD OF CONTROLLING DC-DC CONVERTER

(71) Applicant: FUJITSU LIMITED, Kawasaki-shi (JP)

(72) Inventor: Masafumi KONDOU, Kawasaki (JP)

(21) Appl. No.: 14/454,590

(22) Filed: Aug. 7, 2014

(30) Foreign Application Priority Data
Aug. 28, 2013 (JP) 2013-177084

(51) Int. Cl. H02M 3/158

(52) U.S. Cl. CPC H02M 3/158
USPC 323/271

(57) ABSTRACT

A DC-DC converter includes: an inductor; a first capacitor and a second capacitor; a plurality of switching elements coupled to the inductor, the first capacitor, and the second capacitor; a control circuit configured to control the plurality of switching elements to be switched ON/OFF such that a connection form of the inductor, the first capacitor, and the second capacitor is alternately switched between a first form where the inductor, the first capacitor, and the second capacitor are coupled in series such that the first capacitor and the second capacitor are charged and a second form where the inductor, the first capacitor, and the second capacitor are coupled in parallel such that the first capacitor and the second capacitor are discharged; and a detection circuit configured to detect a difference between each of a voltage across the first capacitor and a voltage across the second capacitor.

### CROSS-REFERENCE TO RELATED APPLICATION

This application is based upon and claims the benefit of priority of the prior Japanese Patent Application No. 2013-177084 filed on Aug. 28, 2013, the entire contents of which are incorporated herein by reference.

### FIELD

The embodiments discussed herein are related to a DC-DC converter and a method of controlling the DC-DC converter.

### BACKGROUND

Various electronic apparatuses such as computers are provided with a switching power supply that supplies a driving voltage. A DC-DC converter is used as, for example, a switching power supply and charges/discharges a capacitor by a switching operation of a transistor or the like to convert an input voltage into a predetermined voltage.

The DC-DC converter includes electronic components such as an inductor, and a capacitor. Among these electronic components, a relatively large component such as, for example, an inductor, is hard to be accommodated in an integrated circuit (IC) of a power supply circuit due to the constraints on a mounting space. Therefore, for the DC-DC converter, it is requested that the size of such an inductor and capacitor needs to be minimized while maintaining the standard of ripples (noises) of an output voltage;

The square of a switching operation frequency of the DC-DC converter is proportional to 1/LC (L: inductance of an inductor, C: capacitance of a capacitor). Therefore, when the switching operation frequency is increased, the size of the inductor and capacitor may be reduced.

However, when the switching operation frequency is increased, power loss is also increased due to the charging/discharging operation of the capacitor, which may result in deterioration of conversion efficiency.

The followings are reference documents.

[Document 1] Japanese Laid-Open Patent Publication No. 2002-320377,

[Document 2] Japanese National Publication of International Patent Application No. 2003-529311 and

[Document 3] Japanese Laid-Open Patent Publication No. 2002-84739.

### SUMMARY

According to an aspect of the invention, a DC-DC converter includes: an inductor; a first capacitor and a second capacitor; a plurality of switching elements coupled to the inductor, the first capacitor, and the second capacitor; a control circuit configured to control the plurality of switching elements to be switched ON/OFF such that a connection form of the inductor, the first capacitor, and the second capacitor is alternately switched between a first form where the inductor, the first capacitor, and the second capacitor are coupled in series such that the first capacitor and the second capacitor are charged and a second form where the inductor, the first capacitor, and the second capacitor are coupled in parallel such that the first capacitor and the second capacitor are discharged; and a detection circuit configured to detect a difference between each of a voltage across the first capacitor and a voltage across the second capacitor, wherein the control circuit controls an ON/OFF switching of the plurality of switching elements such that the connection form is set to a third form where both ends of the inductor are respectively coupled to a reference potential via the first capacitor and the second capacitor before the connection form is switched from the first form to the second form and, in the third form, both ends of the inductor are short-circuited when the voltage difference detected by the detection circuit becomes equal to or less than a predetermined value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a circuit diagram illustrating a circuit configuration of a DC-DC converter according to a first comparative example;

FIG. 2 is a circuit diagram illustrating a circuit configuration of a DC-DC converter according to a second comparative example;

FIG. 3 is a circuit diagram illustrating a circuit configuration of a DC-DC converter and a control circuit according to a third comparative example;

FIGS. 4A and 4B are circuit diagrams illustrating equivalent circuits of the DC-DC converter according to the third comparative example;

FIGS. 5A to 5C are graphs illustrating results of simulation of a current and a voltage of the DC-DC converter according to the third comparative example when a duty ratio is 0.2;

FIGS. 6A to 6C are graphs illustrating results of simulation of a current and a voltage of the DC-DC converter according to the third comparative example when a duty ratio is 0.5;

FIG. 7 illustrates a table representing the quality of performances according to the first to third comparative examples;

FIG. 8 is a circuit diagram illustrating a circuit configuration of a DC-DC converter and a control circuit according to an exemplary embodiment;

FIG. 9 illustrates an ON/OFF control of switching elements by a control circuit and an inductor current;

FIGS. 10A and 10B are circuit diagrams illustrating a circuit of the DC-DC converter in an operation mode φ1 and its equivalent circuit;

FIGS. 11A and 11B are circuit diagrams illustrating a circuit of the DC-DC converter in an operation mode φ2 and its equivalent circuit;

FIGS. 12A and 12B are circuit diagrams illustrating a circuit of the DC-DC converter in an operation mode φ3 and its equivalent circuit;

FIGS. 13A and 13B are circuit diagrams illustrating a circuit of the DC-DC converter in an operation mode φ4 and its equivalent circuit;

FIGS. 14A and 14B are circuit diagrams illustrating a circuit of the DC-DC converter in an operation mode φ1s and its equivalent circuit;

FIGS. 15A and 15B are circuit diagrams illustrating a circuit of the DC-DC converter in an operation mode φ4s and its equivalent circuit;

FIGS. 16A to 16D are graphs illustrating a result of simulation of a current and a voltage of the DC-DC converter according to the exemplary embodiment;

FIG. 17 is a circuit diagram illustrating a circuit of a DC-DC converter according to another exemplary embodiment;

FIGS. 18A and 18B are graphs illustrating a change of an application voltage of a switching element in a case where there is a protection circuit and a case where there is not a protection circuit; and

FIG. 19 is a table representing the quality of performances according to the first to third comparative examples and the exemplary embodiment.

### DESCRIPTION OF EMBODIMENTS

### First Comparative Example

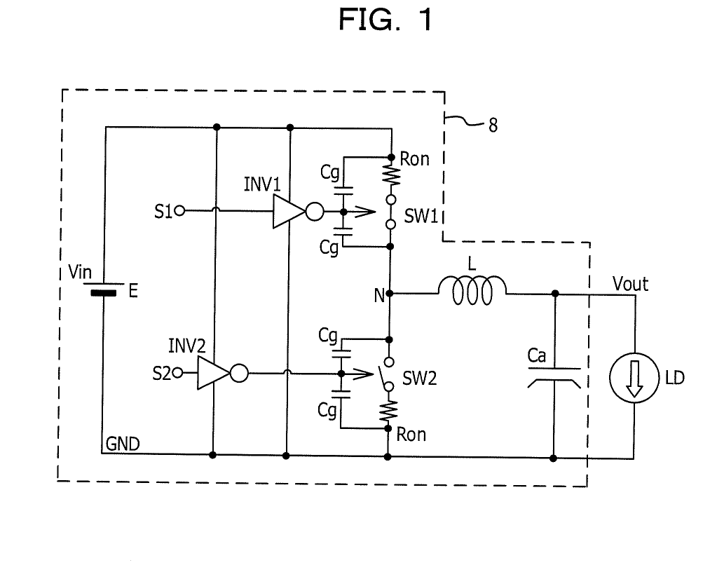

FIG. 1 is a circuit diagram illustrating a circuit configuration of a DC-DC converter according to a first comparative example. The illustrated DC-DC converter 8 may be referred to as, for example, an LC type step-down converter.

The DC-DC converter 8 includes a first inverter INV1, a second inverter INV2, a first switching element SW1, a second switching element SW2, an inductor L and a capacitor Ca. The DC-DC converter 8 is connected to an input power supply E and a load LD to convert an input voltage Vin output from the input power supply E into an output voltage Vout lower than the input voltage Vin and to output the output voltage Vout to the load LD.

The DC-DC converter 8 converts the input voltage Vin into the output voltage Vout by controlling ON/OFF switching of the first switching element SW1 and the second switching element SW2. Each of the first switching element SW1 and the second switching element SW2 is, for example, a field effect transistor (FET) and has an on-resistance Ron and a gate capacitance Cg. For the convenience of description, FIG. 1 illustrates the on-resistance Ron and the gate capacitance Cg separately from the first switching element SW1 and the second switching element SW2.

One terminal of the first switching element SW1 is connected in series to one terminal of the second switching element SW2, the other terminal of the first switching element SW1 is connected to a positive (+) terminal of the input power supply E, and the other terminal of the second switching element SW2 is grounded. The first inverter INV1 and the second inverter INV2 are respectively connected to control terminals (e.g., gate terminals) of the first switching element SW1 and the second switching element SW2.

The first switching element SW1 and the second switching element SW2 are controlled to be switched ON/OFF according to control signals S1 and S2 input to the control terminals via the first inverter INV1 and the second inverter INV2, respectively. More specifically, the first switching element SW1 and the second switching element SW2 are controlled to be switched ON/OFF in an alternating manner.

The inductor L has one end connected to a node N between the first switching element SW1 and the second switching element SW2 and the other end connected to one end of the capacitor Ca. The other end of the capacitor Ca is connected to a reference potential GND.

The capacitor Ca is connected in parallel to the load LD. The capacitor Ca is charged when the first switching element SW1 is in an ON state and the second switching element SW2 is in an OFF state, and is discharged when the first switching element SW1 is in an OFF state and the second switching element SW2 is in an ON state. The inductor L causes electromagnetic induction when the first switching element SW1 and the second switching element SW2 are switched ON/OFF. Thus, the output voltage Vout is output to the load LD.

The DC-DC converter 8 may provide high efficiency at a heavy load (i.e., when a current flowing into the coil L is large) since the DC-DC converter 8 does not use a resistor. In addition, the DC-DC converter 8 may adjust a ratio of output voltage Vout to input voltage Vin (Vout/Vin) by adjusting a duty ratio of the control signals S1 and S2 (PWM signals) for driving the first switching element SW1 and the second switching element SW2.

However, when each of the first switching element SW1 and the second switching element SW2 is in the OFF state, the input voltage Vin is applied between terminals (e.g., between a source terminal and a drain terminal). Here, since each of the first switching element SW1 and the second switching element SW2 has the on-resistance Ron and the gate capacitance Cg, for example, a power loss of Cg×Vin2 occurs. In the following description, a voltage applied to a switching element in an OFF state is referred to as a “stress voltage.”

In the DC-DC converter 8, in case of using transistors for the switching elements SW1 and SW2, parameters that affect the power loss may include the on-resistance Ron and gate capacitance Cg of the transistors. Therefore, when fine transistors are used, power loss of the DC-DC converter may be reduced. However, since the thickness of the gate oxide film is reduced, withstand voltage performance may be deteriorated. That is, there is a trade-off relationship between the withstand voltage and the power loss of the transistors.

In addition, the input voltage Vin may not be reduced since it is determined based on a design specification. Therefore, it is desirable to provide a DC-DC converter with a reduced stress voltage in order to reduce the power loss.

### Second Comparative Example

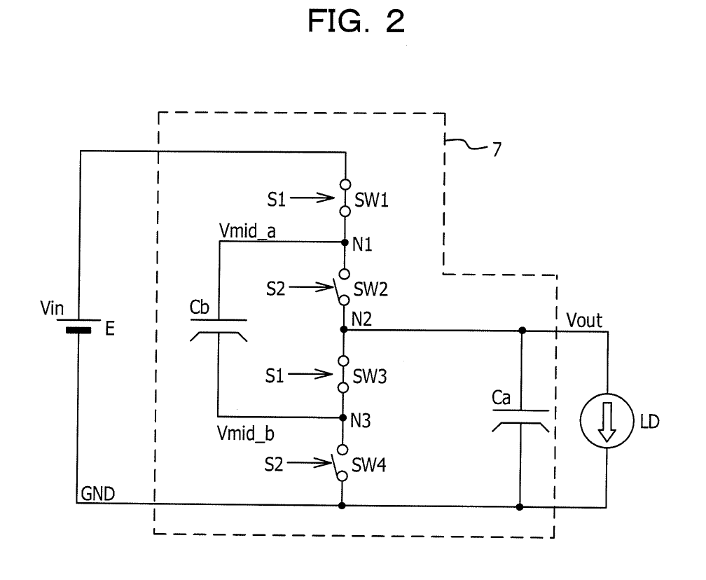

FIG. 2 is a circuit diagram illustrating a circuit configuration of a DC-DC converter according to a second comparative example. The illustrated DC-DC converter 7 may be referred to as, for example, a switched capacitor type step-down converter. The DC-DC converter 7 is connected to an input power supply E and a load LD to convert an input voltage Vin output from the input power supply E into an output voltage Vout lower than the input voltage Vin and output the output voltage Vout to the load LD.

The DC-DC converter 7 includes first to fourth switching elements SW1 to SW4, a first capacitor Cb, and a second capacitor Ca. The first to fourth switching elements SW1 to SW4 are, for example, FETs connected in series. The first switching element SW1 has one terminal connected to a positive (+) terminal of the input power supply E and the other terminal connected to one terminal of the second switching element SW2. The fourth switching element SW4 has one terminal connected to one terminal of the third switching element SW3 and the other terminal connected to a negative (−) terminal of the input power supply (i.e., GND).

The first capacitor Cb has one end connected to a node N1 between the first switching element SW1 and the second switching element SW2 and the other end connected to a node N3 between the third switching element SW3 and the fourth switching element SW4. The second capacitor Ca is connected in parallel to the load LD and has one end connected to a node N2 between the second switching element SW2 and the third switching element SW3 and the other end connected to a reference potential (GND).

The first switching element SW1 and the third switching element SW3 are controlled to be switched ON/OFF according to a control signal S1 input to the control terminals thereof, and the second switching element SW2 and the fourth switching element SW4 are controlled to be switched ON/OFF according to a control signal S2 input to the control terminals thereof. The control signals Si and S2 exhibit different levels in two operation modes φ1 and φ2 which are periodically switched.

In the operation mode φ1, the first switching element SW1 and the third switching element SW3 are brought into the ON state and the second switching element SW2 and the fourth switching element SW4 are brought into OFF state. In the operation mode φ2, the first switching element SW1 and the third switching element SW3 are brought into the OFF state and the second switching element SW2 and the fourth switching element SW4 are brought into the ON state.

Accordingly, in the operation mode φ1, the first capacitor Cb and the second capacitor Ca are connected in series and are charged by the input power supply E. In the operation mode φ2, the first capacitor Cb and the second capacitor Ca are connected in parallel and are discharged.

Therefore, since a voltage across the first capacitor Cb and the second capacitor Ca is 0.5×Vin, a stress voltage of the first to fourth switching element SW1 to SW4 is also 0.5×Vin. Accordingly, assuming the gate capacitance is represented by Cg, the power loss becomes Cg×(0.5×Vin)². For this reason, when the gate capacitance Cg is equal to that in the first comparative example, the power loss is lower than that in the first comparative example. Thus, in the second comparative example, fine transistors may be used for the first to fourth switching elements SW1 to SW4, which may improve the efficiency of the DC-DC converter 7.

However, in this DC-DC converter 7, since Vout/Vin is maintained at 0.5, Vout/Vin may not be adjusted based on a duty ratio, unlike the first comparative example. In addition, assuming the capacitances of the first capacitor Cb and the second capacitor Ca are represented by Ca and Cb, respectively, only the parameter of Ca=Cb is selected in practice in order to reduce the power loss occurring in the operation mode φ2. In addition, in the operation mode φ2, since the first capacitor Cb draws a current, the efficiency at a heavy load is reduced in principle.

### Third Comparative Example

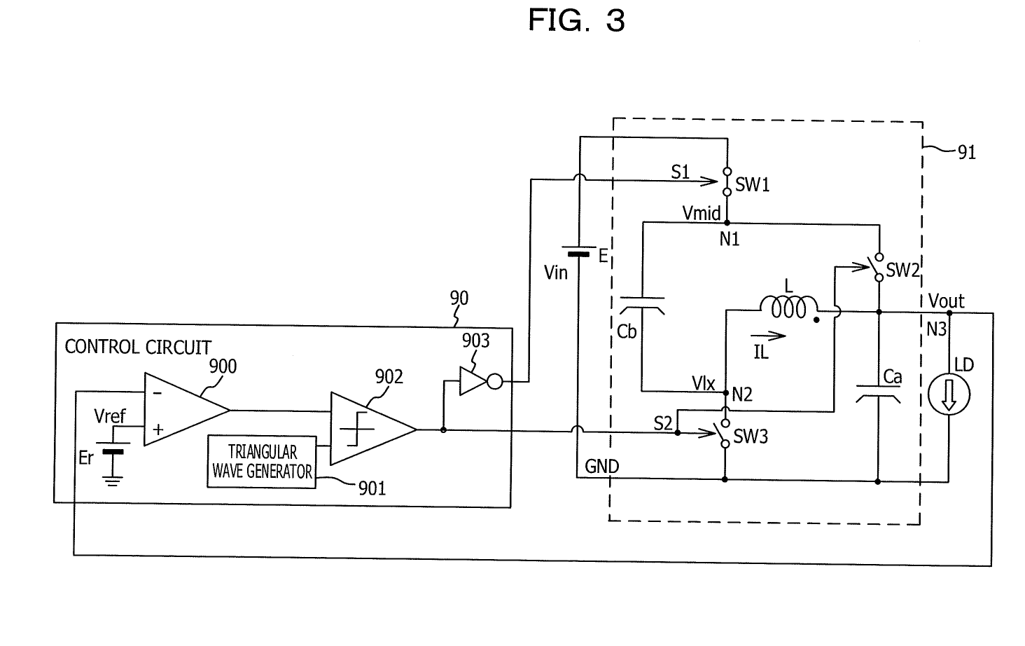

FIG. 3 is a circuit diagram illustrating a circuit configuration of a DC-DC converter and a control circuit according to a third comparative example. The illustrated DC-DC converter 91 includes a first switching element SW1, a second switching element SW2, a third switching element SW3, an inductor L, a first capacitor Cb, and a second capacitor Ca. The DC-DC converter is connected to an input power supply E and a load LD to convert an input voltage Vin output from the input power supply E into an output voltage Vout lower than the input voltage Vin and output the output voltage Vout to the load LD.

The first to third switching elements SW1 to SW3 are, for example, FETs. The third switching element may be a diode.

The first switching element SW1 has one terminal connected to a positive (+) terminal of the input power supply E and the other terminal connected to one end of the first capacitor Cb and one terminal of the second switching element SW2. The inductor L has one end connected to an output terminal N3, the one terminal of the second switching element SW2, and one end of the second capacitor Ca, and the other end connected to the other end of the first capacitor Cb and one terminal of the third switching element SW3. The other end of the second capacitor Ca and the other terminal of the third switching element SW3 are connected to a reference potential (GND). The second capacitor Ca is connected in parallel to the load LD.

The first switching element SW1 is controlled to be switched ON/OFF according to a control signal S1 input from a control circuit 90 to a control terminal. The second switching element SW2 and the third switching element SW3 are controlled to be switched ON/OFF according to a control signal S2 input from the control circuit 90 to their respective control terminals. The control signals S1 and S2 exhibit different levels in two operation modes φ1 and φ2 which are alternately switched.

In the operation mode φ1, the first switching element SW1 is brought into an ON state and the second switching element SW2 and the third switching element SW3 are brought into the OFF state. In the operation mode φ2, the first switching element SW1 is brought into the OFF state and the second switching element SW2 and the third switching element SW3 are brought into an ON state.

The first to third switching elements SW1 to SW3 are controlled to be switched ON/OFF by the control circuit 90. The control circuit 90 includes a reference power supply Er, an error amplifier 900, a triangular wave generator 901, a comparator 902, and an inverter 903.

The error amplifier 900 amplifies a voltage difference between an output voltage Vout of the DC-DC converter 91 and a reference voltage Vref output from the reference power supply Er and outputs the amplified voltage difference to the comparator 902. The comparator 902 compares the voltage difference input from the error amplifier 900 with a triangular wave input from the triangular wave generator 901, and based on a result of the comparison, generates and outputs the control signal S2 to the DC-DC converter 91. The control signal S2 is generated to repeat a high level and a low level by a feedback of the output voltage Vout.

The inverter 903 performs logical inversion of the control signal S2 to generate the control signal S1 which is in turn output to the DC-DC converter 91. The control signal S1 is input to the control terminal of the first switching element SW1 and the second control signal S2 is input to the control terminals of the second switching element SW2 and the third switching element SW3.

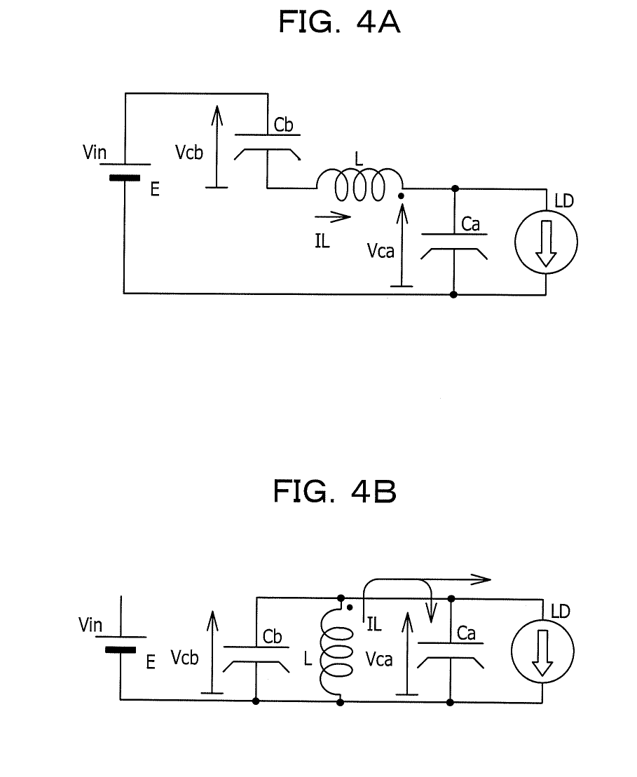

FIGS. 4A and 4B are circuit diagrams illustrating equivalent circuits of the DC-DC converter 91 according to the third comparative example. FIG. 4A illustrating an equivalent circuit diagram in the operation mode φ1 and FIG. 4B illustrating an equivalent circuit diagram in the operation mode φ2.

In the operation mode φ1, the inductor L, the first capacitor Cb, and the second capacitor Ca are connected in series, and the first capacitor Cb and the second capacitor Ca are charged by the input power supply E. In the operation mode φ2, the inductor L, the first capacitor Cb, and the second capacitor Ca are connected in parallel, and the first capacitor Cb and the second capacitor Ca are discharged.

The DC-DC converter 91 may adjust Vout/Vn based on duty ratios of the control signals S1 and S2. A process of deriving Vout/Vin will be described below.

Assuming that inductance of the inductor L is L and a voltage across the inductor L is V, the voltage V may be represented by the following equation (1) based on the temporal change Δi/Δt of an inductor current IL.

V=L·Δi/Δt (1)

Accordingly, the following equation (2) is established.

ΔI=(V/L)·Δt (2)

Assuming that one cycle of the operation of the DC-DC converter 91 is Tp, a period of increase of the inductor current IL (period of the operation mode φ1) is Tp·Duty and a period of decrease of the inductor current IL (period of the operation mode φ2) is Tp·(1−Duty). Here, Duty is a duty ratio.

In one cycle, it is assumed that an amount of increase in the inductor current IL in the operation mode φ1 is Δᵢᵣᵢₛₑ and a voltage applied to the inductor L at that time is Vᵣᵢₛₑ. It is also assumed that an amount of decrease in the inductor current IL in the operation mode φ2 is Δi_{fall} and a voltage applied to the inductor L at that time is V_{fall}. In this case, based on the equation (2), the following equations (3) and (4) are established.

Δᵢᵣᵢₛₑ=(Vᵣᵢₛₑ·Tp/L)·Duty (3)

Δifall=(V_{fall}·Tp/L)·(1−Duty) (4)

Here, assuming that a switching frequency is fsw, the period is 1/fsw and thus, the following equations (5) and (6) are established based on the equations (3) and (4).

Δiᵣᵢₛₑ={Vᵣᵢₛₑ/(L·fsw)}·Duty (5)

Δi_{fall}={V_{fall}/(L·fsw)}·(1−Duty) (6)

Here, the voltages Vᵣᵢₛₑ and V_{fall} are expressed by the following equations (7) and (8), respectively, based on the equivalent circuit illustrated in FIG. 4.

Vᵣᵢₛₑ=Vin−2Vout (7)

V_{fall}=Vout (8)

In addition, since the amount of increase in the current Δiᵣᵢₛₑ is equal to the amount of decrease in the current Δi_{fall} in one cycle (conditions for equilibrium of ripple current), the following equation (9) is obtained instead of the equations (5) to (8).

(Vin−2Vout)/(L·fsw)·Duty=Vout/(L·fsw)·(1−Duty) (9)

Therefore, Vout/Vin is represented by the following equation (10).

Vout/Vin=Duty/(1+Duty) (10)

Accordingly, Vout/Vin can be controlled based on the duty ratio Duty.

In addition, stress voltages Vsw1 to Vsw3 of the first to third switching elements SW1 to SW3 are represented by the equations (11) to (13), respectively, based on FIG. 4.

Vsw1=Vin−Vmid=Vin−Vout (11)

Vsw2=Vmid−Vout=(Vin−2Vout)+Vout=Vin−Vout (12)

Vsw3=Vlx−0=(Vin−2Vout)+Vout=Vin−Vout (13)

Here, as illustrated in FIG. 3, Vmid is a potential of the node N1 between the first switching element SW1 and the first capacitor Cb and Vlx is a potential of the node N2 between the first capacitor Cb and the third switching element SW3.

Thus, since the stress voltages Vsw1 to Vsw3 are smaller than the input voltage Vin, the DC-DC converter 91 in the third comparative example may employ fine transistors for the first to third switching elements SW1 to SW3.

In the DC-DC converter 91, a voltage Vcb across the first capacitor Cb is not equal to a voltage Vca across the second capacitor Ca immediately before the converter 91 shifts from the operation mode φ1 to the operation mode φ2. Therefore, at the moment the potential Vmid of the node N1 becomes equal to the output voltage Vout, a current flows into the input power supply E, which may result a power loss.

In the operation mode φ2, the voltage Vcb across the first capacitor Cb and the voltage Vca across the second capacitor Ca are decreased by discharging. At this time, the inductor current IL flows into the second capacitor Ca as well as the load LD, as illustrated in FIG. 4B.

Therefore, a rate of decrease in the voltage Vca across the second capacitor Ca is smaller than a rate of decrease in the voltage Vcb across the first capacitor Cb. Accordingly, when the voltage Vca across the second capacitor Ca is higher than the voltage Vcb across the first capacitor Cb, a current flows from the second capacitor Ca into the input power supply E, which may result in power loss. For this reason, efficiency at a heavy load deteriorates.

When the capacitance of the first capacitor Cb is not equal to the capacitance of the second capacitor Ca, additional power loss may be caused in the DC-DC converter 91 for the above-mentioned reason. As a result, since there is no other way than setting of Ca=Cb in practice, flexibility in selecting a circuit constant is low.

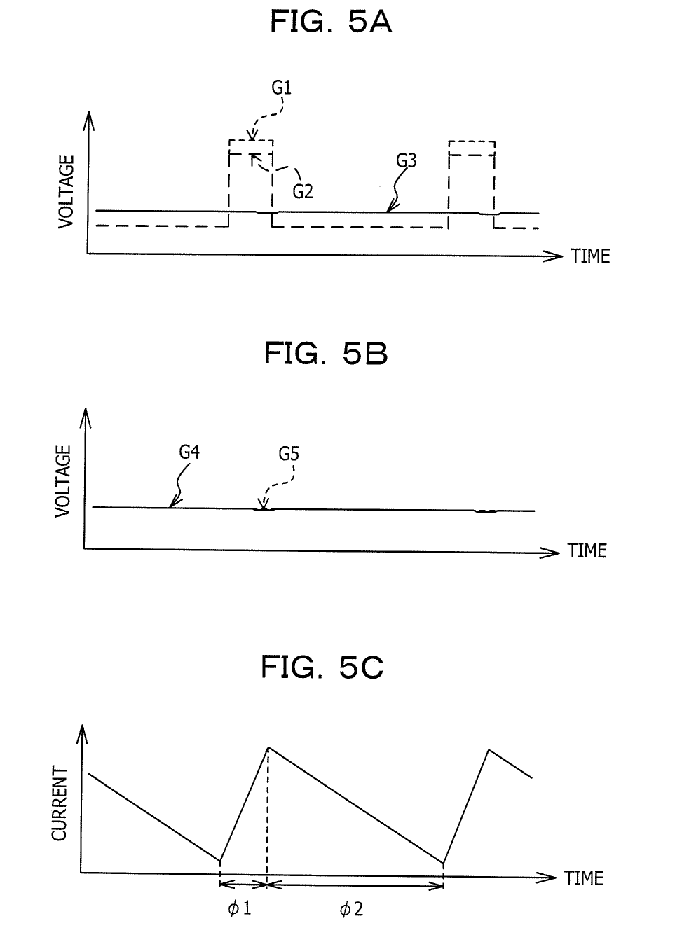

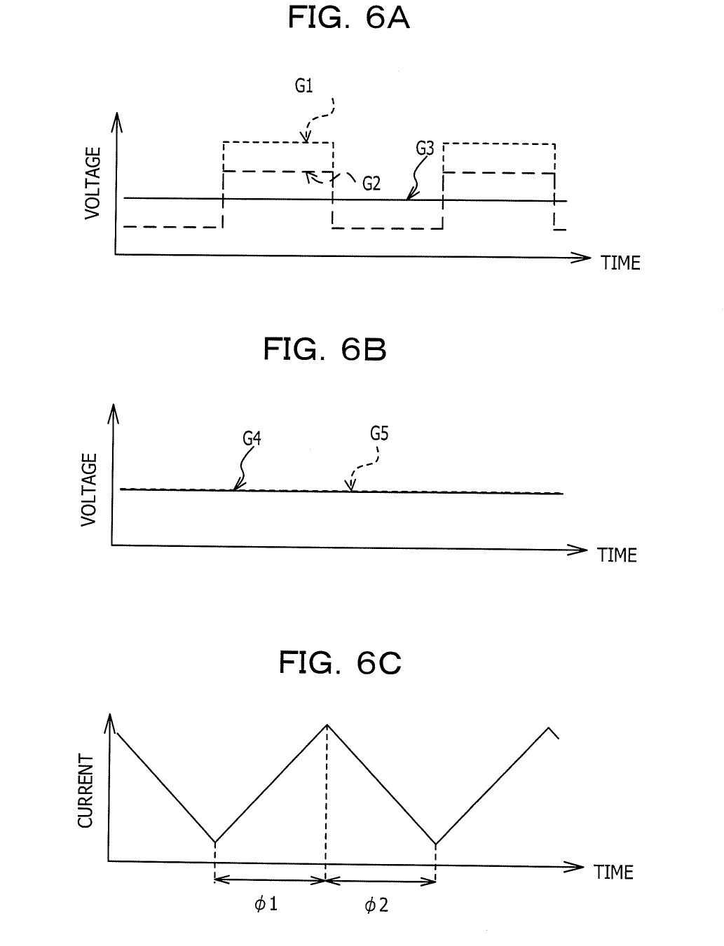

FIGS. 5A to 5C are graphs illustrating results of simulation of a current and a voltage of the DC-DC converter according to the third comparative example when the duty ratio is 0.2. FIGS. 6A to 6C are graphs illustrating results of simulation of a current and a voltage of the DC-DC converter according to the third comparative example when the duty ratio is 0.5.

FIGS. 5A and 6A illustrate the potential Vmid (indicated by dotted line G1) of the node N1, the potential Vlx (indicated by dotted line G2) of the node N2, and the output voltage Vout (indicated by solid line G3). FIGS. 5B and 6B illustrate the voltage Vcb (indicated by dotted line G5) across the first capacitor Cb, and the voltage Vca (indicated by solid line G4) across the second capacitor Ca. In these figures, the voltage Vca across the second capacitor Ca is equal to the output voltage Vout.

FIGS. 5C and 6C illustrate the inductor current IL. The inductor current IL increases when the DC-DC converter 91 is operated in the operation mode φ1 while the inductor current decreases when the DC-DC converter 91 is operated in the operation mode φ2. As can be understood from comparison of FIGS. 5C and 6C, a time ratio of the operation modes φ1 and φ2 in one cycle is changed depending on the duty ratio.

In the period of the operation mode φ1, the potentials Vmid and Vlx increase since the first capacitor Cb and the second capacitor Ca are charged. On the other hand, in the period of the operation mode φ2, the potentials Vmid and Vlx decrease since the first capacitor Cb and the second capacitor Ca are discharged.

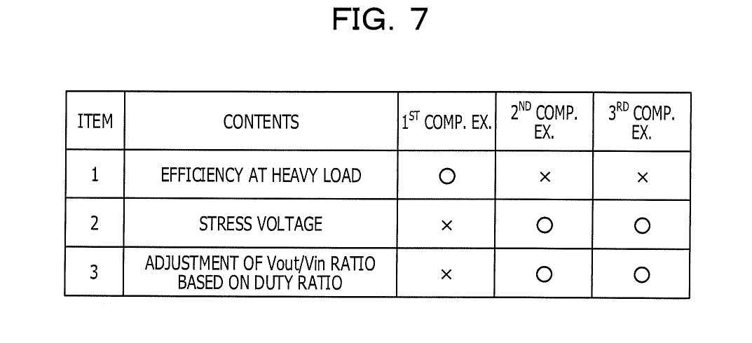

FIG. 7 illustrates the quality of the performances according to the first to third comparative examples. As described above, in terms of the efficiency at the heavy load (item 1), the DC-DC converter of the first comparative example is good (marked by O) while the DC-DC converters of the second and third comparative examples are bad (marked by X). In terms of the stress voltage (item 2), the DC-DC converter of the first comparative example is bad (marked by X) while the DC-DC converters of the second and third comparative examples are good (marked by O). In terms of the adjustment of Vin/Vout by the duty ratio (item 3), the DC-DC converter of the second comparative example is bad (marked by X) while the DC-DC converters of the first and third comparative examples are good (marked by O).

### Exemplary Embodiment

A DC-DC converter according to an exemplary embodiment improves the heavy load efficiency (item 1). In this DC-DC converter, the efficiency is improved by connecting two capacitors, which are connected in series at the time of charging and connected in parallel at the time of discharging, to both ends of an inductor and a reference potential before discharging, and short-circuiting the both ends of the inductor when voltages across the capacitors are equal to each other. The DC-DC converter according to the exemplary embodiment will be described in detail below.

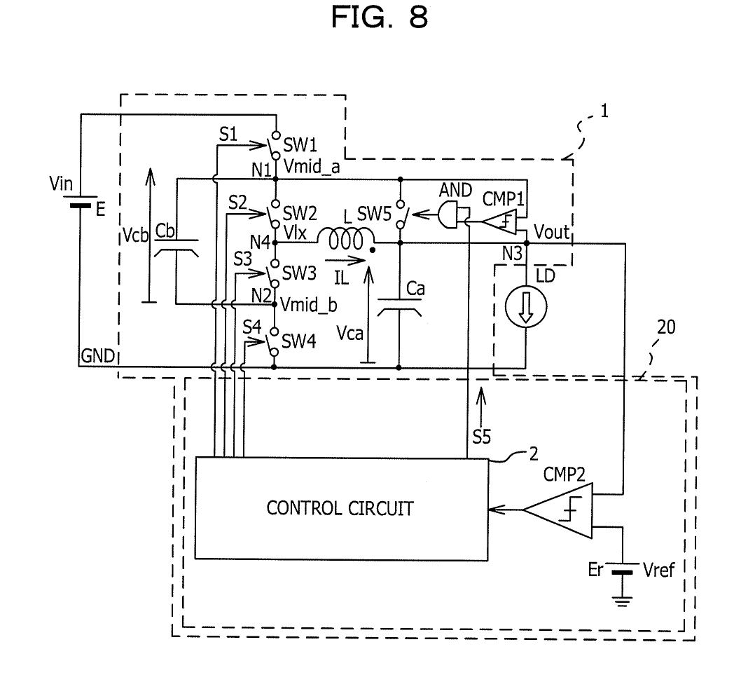

FIG. 8 is a circuit diagram illustrating a circuit configuration of the DC-DC converter and a control circuit according to the exemplary embodiment. The illustrated DC-DC converter 1 includes an inductor L, a first capacitor Cb, a second capacitor Ca, first to fifth switching elements SW1 to SW5, a logic gate AND, a comparator (detection circuit) CMP1, and a control unit 20.

The DC-DC converter 1 is connected to an input power supply E and a load LD to convert an input voltage Vin output from the input power supply E into an output voltage Vout lower than the input voltage Vin and output the output voltage Vout to the load LD. One end (first terminal) of the inductor L and one end (first terminal) of the second capacitor Ca are connected to the load LD and the other end (second terminal) of the second capacitor Ca is connected to a reference potential (GND). Since the second capacitor Ca is connected in parallel to the load LD, a potential of the one end (first terminal) of the second capacitor Ca, i.e. an output terminal N3, is equal to the output voltage Vout.

The first to fifth switching elements SW1 to SW5 are, for example, FETs. The first to fourth switching elements SW1 to SW4 are connected in series between a positive (+) terminal and a negative (−) terminal (i.e., the reference potential (GND)) of the input power supply E.

The first switching element SW1 has one terminal connected to the (external) input power supply E and the other terminal connected to one end (first terminal) of the first capacitor Cb. The second switching element SW2 has one terminal connected to the one end (first terminal) of the first capacitor Cb and the other terminal connected to the other end (second terminal) of the inductor L. Meanwhile, it is assumed a potential of the one end (first terminal) of the first capacitor Cb, i.e., a node N1 between the first switching element SW1 and the second switching element SW2 is Vmid_a.

The third switching element SW3 has one terminal connected to the other end (second terminal) of the inductor L and the other terminal connected to the other end (second terminal) of the first capacitor Cb. The fourth switching element SW4 has one terminal connected to the other end (second terminal) of the first capacitor Cb and the other terminal connected to the reference potential. Here, it is assumed that a potential of the other end (second terminal) of the first capacitor Cb, i.e., a node N2 between the third switching element SW3 and the fourth switching element SW4 is Vmid_b.

The first to fourth switching elements SW1 to SW4 have their respective control terminals (e.g., gate terminals) connected to a control circuit 2. Thus, the first to fourth switching elements SW1 to SW4 are ON/OFF controlled by control signals S1 to S4 input from the control circuit 2, respectively.

The fifth switching element SW5 has one terminal connected to the one end (first terminal of the first capacitor Cb) and the other end connected to the one end (first terminal) of the inductor L. The fifth switching element SW5 has a control terminal (for example, a gate terminal) connected to the logic gate.

The comparator CMP1 has one input terminal connected to the one end of the first capacitor Cb and the other input terminal connected to the one end of the second capacitor Ca. The comparator CMP1 also has an output terminal connected to one of the input terminals of the logic gate AND.

The comparator CMP1 detects a difference between a voltage Vcb across the first capacitor Cb and a voltage Vca across the second capacitor Ca. Here, since the switching element SW4 is connected between the first capacitor Cb and the reference potential GND, the difference between the voltages Vca and Vcb may be close to zero only when the switching element SW4 is in the ON state. The comparator CMP1 outputs a detection signal to the logic gate AND when the difference between the voltages Vca and Vcb becomes a predetermined value or less.

The logic gate AND has one input terminal connected to the output terminal of the comparator CMP1 and the other input terminal connected to the control circuit 2. The logic gate AND also has an output terminal connected to a control terminal of the fifth switching element SW5.

Thus, the fifth switching element SW5 is controlled to be switched ON/OFF by the detection signal input from the comparator CMP1 and a control signal input from the control circuit 2. More specifically, the control circuit 2 controls the output of the detection signal from the comparator CMP1 to the fifth switching element SW5 by outputting the control signal S5 to the logic gate AND.

The control unit 20 includes the control circuit 2, a hysteresis comparator CMP2, and a reference power supply Er. The control circuit 2 controls an operation mode of the DC-DC converter 1 by controlling the first to fifth switching elements SW1 to SW5 to be switched ON/OFF. The control circuit 2 is connected to the first to fifth switching elements SW1 to SW5 and a hysteresis comparator CMP2.

The hysteresis comparator CMP2 has one input terminal connected to an output terminal N3 and the other input terminal connected to the reference power supply Er. The hysteresis comparator CMP2 detects a voltage difference between the output voltage Vout of the DC-DC converter 1, which is supplied from the output terminal N3, and the reference voltage Vref of the reference power supply Er and outputs a detection signal to the control circuit 2.

The control circuit 2 determines an operation state of the DC-DC converter 1 based on the detection signal input from the hysteresis comparator CMP2 and outputs the control signals S1 to S5 to the first to fifth switching elements SW1 to SW5, respectively. The control circuit 2 switches the DC-DC converter 1 between operation modes φ1 to φ4 sequentially in response to the operation state by the ON/OFF controlling of the first to fifth switching elements SW1 to SW5.

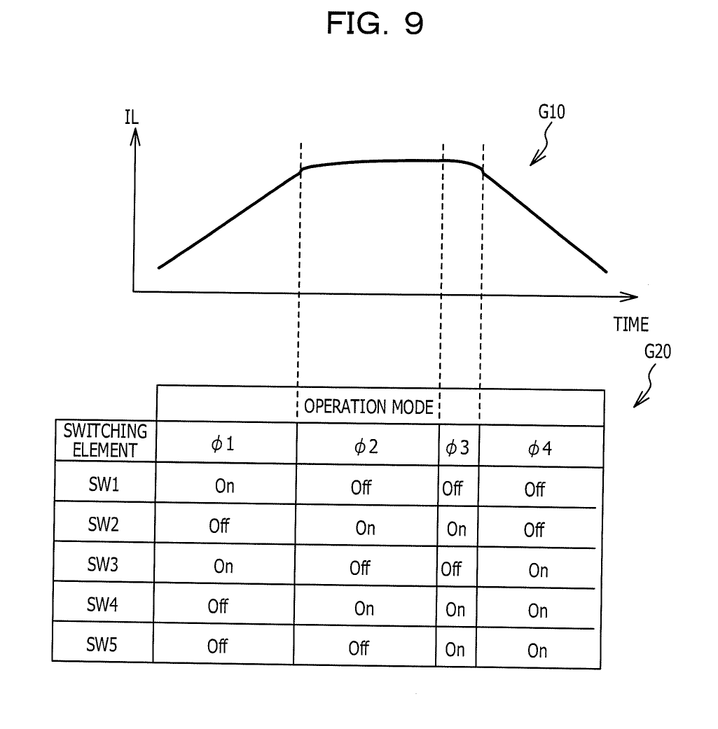

FIG. 9 illustrates an ON/OFF control of the switching elements SW1 to SW5 by the control circuit 2 and an inductor current IL. In the figure, reference numeral G10 denotes a temporal change of the inductor current IL flowing into the inductor L and reference numeral G20 denotes a state (ON-state (“On”) or OFF-state (“Off”)) of the first to fifth switching elements SW1 to SW5 for each of the operation modes φ1 to φ4.

In the DC-DC converter 1, the inductor L, the first capacitor Cb, and the second capacitor Ca are different from each other in connection form in different operation modes φ1 to φ4. In the operation mode φ1 (first form), the first switching element SW1 and the third switching element SW3 are in the ON state and the second switching element SW2, the fourth switching element SW4, and the fifth switching element SW5 are in the OFF state. Thus, the inductor L, the first capacitor Cb, and the second capacitor Ca are connected in series and the first capacitor Cb and the second capacitor Ca are charged to increase the inductor current IL.

In the operation mode φ2 (third form), the second switching element SW2 and the fourth switching element SW4 are in the ON state and the first switching element SW1, the third switching element SW2, and the fifth switching element SW5 are in the OFF state. Thus, both ends of the inductor L are connected to the reference potential GND via the first capacitor Cb and the second capacitor Ca, respectively, and the inductor current IL smoothly increases.

In the operation mode φ3, the second switching element SW2, the fourth switching element SW4, and the fifth switching element SW5 are in the ON state and the first switching element SW1 and the third switching element SW3 are in the OFF state. Thus, both ends of the inductor L are short-circuited and the voltages Vcb and Vcb across both ends of the first capacitor Cb and the second capacitor Ca become equal to each other such that the inductor current IL smoothly decreases.

In the operation mode φ4 (second form), the first switching element SW1 and the second switching element SW2 are in the OFF state and the third element SW3, the fourth switching element SW4, and the fifth switching element SW5 are in the ON state. Thus, the inductor L, the first capacitor Cb, and the second capacitor Ca are connected in parallel and the first capacitor Cb and the second capacitor Ca are discharged such that the inductor current IL decreases.

The control circuit 2 controls the ON/OFF switching of the switching elements SW1 to SW5 such that the operation modes are alternately switched between the operation mode φ1 and the operation mode φ4. Here, the operation modes φ1 and φ4 correspond to the operation modes φ1 and φ2 in the third comparative example, respectively. The operation modes of the DC-DC converter 1 go through φ2 and φ3 before being switched from φ1 to φ4.

That is, the control circuit 2 controls the ON/OFF switching of the switching elements SW1 to SW5 such that the operation mode goes through φ2 and φ3 before being switched from φ1 to φ4. Thus, the first capacitor Cb and the second capacitor Ca are controlled such that no difference occurs between the voltages Vca and Vcb across the both ends thereof before the discharging (i.e., before the operation mode φ4) to reduce the power loss. The operation modes φ1 to φ4 will be described below.

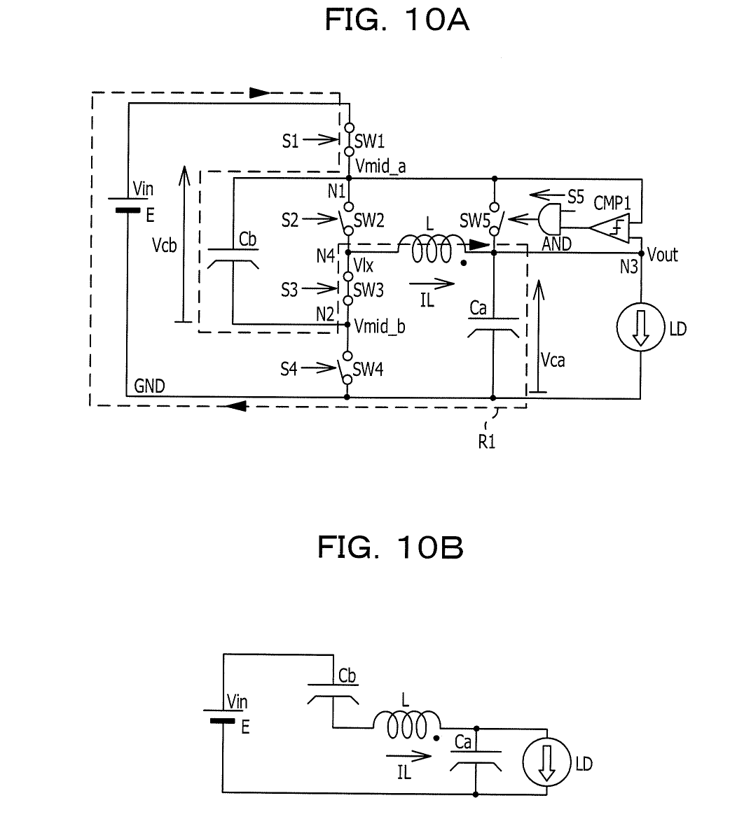

FIGS. 10A and 10B are circuit diagrams illustrating a circuit of the DC-DC converter 1 in the operation mode φ1 and an equivalent circuit thereof, respectively.

In the operation mode φ1, the inductor L, the first capacitor Cb, and the second capacitor Ca are connected in series. Thus, the first capacitor and the second capacitor are charged by the input power supply E to increase the inductor current IL.

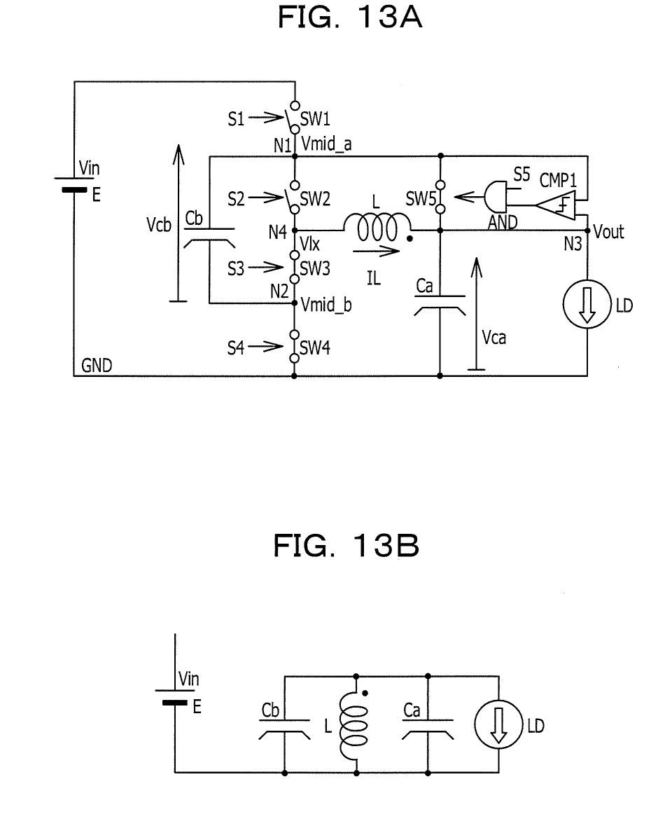

Based on the equivalent circuit of the operation mode φ1 and an equivalent circuit of the operation mode φ4 to be described later (see FIG. 13B), stress voltages of the switching elements SW1 to SW5 in the operation mode φ1 are obtained. The stress voltage of the second switching element SW2 is Vout and the stress voltage of the fourth switching element SW4 and the fifth switching element SW5 are Vin−Vout. Since the first switching element SW1 and the third switching element SW3 are in the ON state, each stress voltage is zero (0). Thus, the stress voltages of the switching elements SW1 to SW5 become less than Vin.

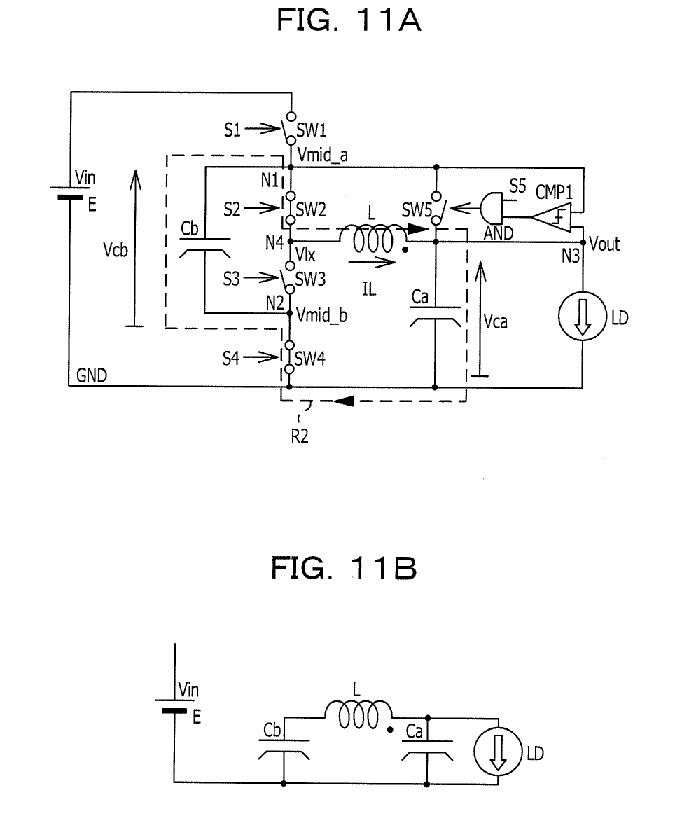

FIGS. 11A and 11B are circuit diagrams illustrating a circuit of the DC-DC converter 1 in the operation mode φ2 and the equivalent circuit, respectively.

In the operation mode φ2, both ends of the inductor L are connected to a reference potential (a negative terminal of the input power supply E) via the first capacitor Cb and the second capacitor Ca, respectively. In an initial state of the operation mode φ2, since an inductor current IL flows into the load LD for charging, the voltage Vcb across the first capacitor Cb is larger than the voltage Vca across the second capacitor Ca (Vcb>Vca).

Due to this, the inductor current IL flows toward the load LD. However, the inductor current gradually increases without being substantially changed. Accordingly, the voltage Vcb across the first capacitor Cb and the voltage Vcb across the second capacitor Ca decrease. At this time, since the second capacitor Ca draws some of the inductor current IL output to the load LD, the amount of decrease in the voltage Vca across the second capacitor Ca per unit time is less than the amount of decrease in the voltage Vcb across the first capacitor Cb per unit time.

Based on the equivalent circuit of the operation mode φ2 and the equivalent circuit of the operation mode φ4 (see FIG. 13B) which will be described later, stress voltages of the switching elements SW1 to SW5 in the operation mode φ2 may be obtained. The stress voltage of the first switching element SW1 is Vin−Vout and the stress voltage of the third switching element SW3 is Vout. Since the second switching element SW2 and the fourth switching element SW4 are in the ON state, their respective stress voltages are zero (0). Thus, the stress voltage of the fifth switching element SW5 becomes close to zero (0) by the inductor L. Thus, the stress voltages of the switching elements SW1 to SW5 become less than Vin.

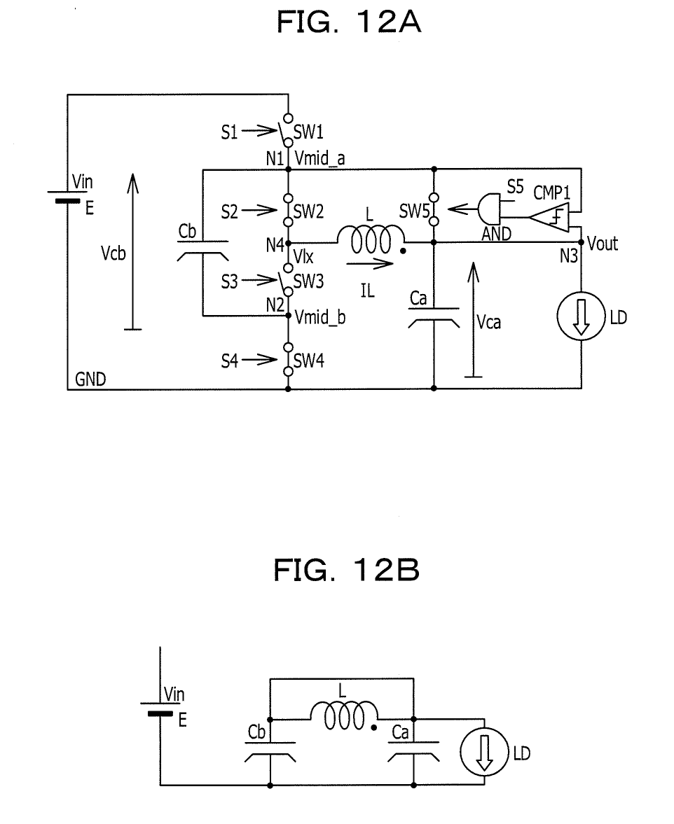

FIGS. 12A and 12B are circuit diagrams illustrating a circuit of the DC-DC converter 1 in the operation mode φ3 and the equivalent circuit thereof, respectively.

The comparator CMP1 detects whether or not the voltage Vcb across the first capacitor Cb becomes equal to the voltage Vca across the second capacitor Ca (Vmid_a=Vout) and outputs a detection signal to the switching element SW5 via the logic gate AND. More specifically, the comparator CMP1 detects whether or not a difference between the voltage Vcb across the first capacitor Cb and the voltage Vca across the second capacitor Ca becomes equal to or less than a predetermined value and outputs the detection signal. At this time, the control signal S5 input to the logic gate AND is set to a level that allows the detection signal to be output to the switching element SW5. For example, when the detection signal is set to be a high level, the control signal S5 is also set to be a high level.

Thus, since the switching element SW5 is brought into the ON state, both ends of the inductor L are short-circuited. That is, when the difference between the voltages Vca and Vcb detected by the comparator CMP1 becomes equal to or less than the predetermined value, the switching elements SW1 to SW5 are controlled to be switched ON/OFF such that the both ends of the inductor L are short-circuited. At this time, since the voltage Vcb across the first capacitor Cb is equal to the voltage Vca across the second capacitor Ca, any power loss due to the short-circuit does not occur. Due to the short-circuit of the both ends of the inductor L, the voltage Vca across the second capacitor Ca is suppressed from exceeding the voltage Vcb across the first capacitor Cb. Therefore, no current flows from the second capacitor Ca to the input power supply E, which may suppress power loss.

When the operation mode is directly shifted from φ2 to φ4, power loss by the inductor current IL occurs, as in the third comparative example. In order to prevent this, a path of the inductor current IL is formed between the first capacitor Cb and the second capacitor Ca in the operation mode φ3 before the operation mode is shifted to φ4.

Thus, since the both ends of the inductor L are short-circuited when the voltage Vcb across the first capacitor Cb becomes equal to the voltage Vca across the second capacitor Ca, no difference occurs between the voltages Vcb and Vca even when the first capacitor Cb and the second capacitor Ca have different capacitances. Accordingly, for the flexibility in selecting the capacitances of the first capacitor Cb and the second capacitor Ca may be improved. Therefore, manufacturing variations which may be caused in the capacitances of the first capacitor Cb and the second capacitor Ca are allowed. In addition, in the operation mode φ3, although no difference occurs between the voltages Vcb and Vca, these voltages decrease as the first capacitor Cb and the second capacitor Ca are discharged.

In addition, since the voltage Vcb across the first capacitor Cb is equal to the voltage Vca across and the second capacitor Ca, the inductor current IL smoothly decreases without being substantially changed. In order to increase the switching frequency of the DC-DC converter 1, it is desirable that the period of the operation mode φ3 is short. In a case where the switching elements SW1 to SW5 are transistors, the period of the operation mode φ3 corresponds to a period required for stabilization of on-resistance of the transistors, for example. This period is determined by, for example, the switching speeds of the transistors.

Based on the equivalent circuit of the operation mode φ3 and the equivalent circuit of the operation mode φ4 (see FIG. 13B) which will be described later, stress voltages of the switching elements SW1 to SW5 in the operation mode φ3 may be obtained. The stress voltage of the first switching element SW1 is Vin−Vout and the stress voltage of the third switching element SW3 is Vout. Since the second switching element SW2, the fourth switching element SW4, and the fifth switching element SW5 are in the ON state, the respective stress voltages thereof are zero (0). Thus, the stress voltages of the switching elements SW1 to SW5 becomes close to zero by the inductor L. Thus, the stress voltages of the switching elements SW1 to SW5 become less than Vin.

FIGS. 13A and 13B are circuit diagrams illustrating a circuit of the DC-DC converter 1 in the operation mode φ4 and the equivalent circuit thereof, respectively.

In the operation mode φ4,the inductor L, the first capacitor Cb, and the second capacitor Ca are connected in parallel. Therefore, the first capacitor Cb and the second capacitor Ca are discharged to decrease the inductor current IL. At this time, since the voltage Vcb across the first capacitor Cb is equal to the voltage Vca across the second capacitor Ca, there is no power loss due to a difference between the voltages Vca and Vcb.

A ratio of output voltage Vout to input voltage Vin is determined by a ratio of period T4 of the operation mode φ4 to period T1 of the operation mode φ1. Therefore, when the sum of the periods T1 and T4 is set to 1, according to the same deriving procedure as the equation (10), Vout/Vin is represented by the following equation (14). Therefore, Vout/Vin may be adjusted by a duty ratio.

Vout/Vin=T1/(1+T1) (14)

In addition, based on the equivalent circuit of the operation mode φ4, stress voltages of the switching elements SW1 to SW5 may be obtained. The stress voltage of the first switching element SW1 is Vin−Vout and the stress voltage of the second switching element SW2 is Vout. Since the third to fifth switching elements SW3 to SW5 are in the ON state, the respective stress voltages thereof are zero (0). Thus, the stress voltages of the switching elements SW1 to SW5 becomes less than Vin.

As described above, the DC-DC converter 1 includes the operation modes φ3 and φ4 between the operation mode φ1 for charging the first capacitor Cb and the second capacitor Ca and the operation mode φ2 for discharging the first capacitor Cb and the second capacitor Ca. In the operation mode φ3, the one end of each of the first capacitor Cb and the second capacitor Ca is connected to the reference potential via the inductor L and the operation mode is shifted to φ2 when the voltages Vcb and Vca across the respective capacitors are equal to each other. In the operation mode φ4, since both ends of the inductor L are short-circuited, no difference occurs between the voltage Vcb across the first capacitor Cb and the voltage Vca across the second capacitor Ca. For this reason, a current is suppressed from flowing toward the input power supply E, which reduces power loss.

In addition, the DC-DC converter 1 may include an operation mode φ1s between the operation modes φ1 and φ2 in order to maintain continuity of the inductor current IL when the operation mode is switched from φ1 to φ2. For current paths of the inductor current IL, a current path of the inductor current IL in the operation mode φ1 is denoted by reference numeral R1 in FIG. 10A and a current path of the inductor current IL in the operation mode φ2 is denoted by reference numeral R2 in FIG. 11A.

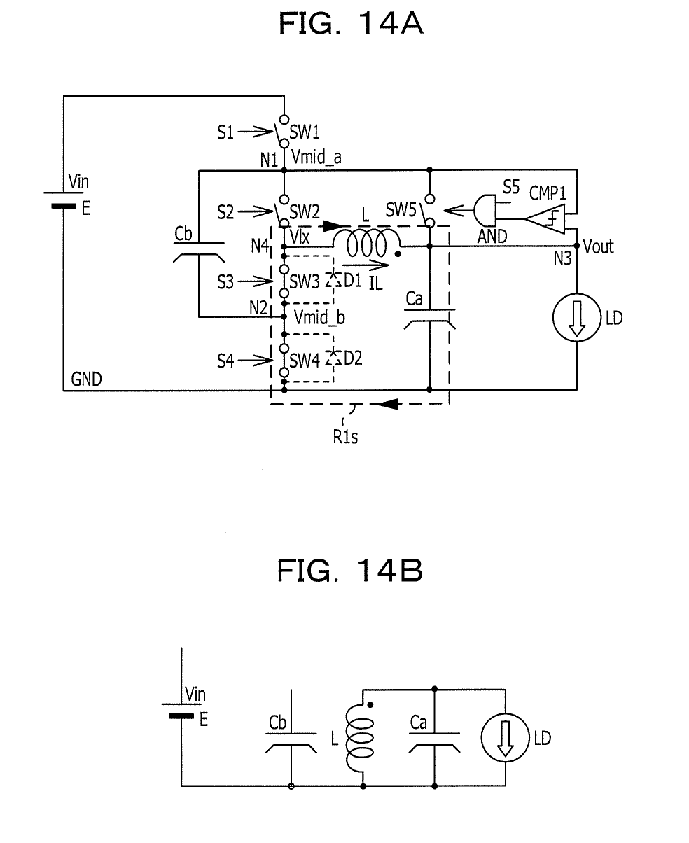

FIGS. 14A and 14B are circuit diagrams illustrating a circuit of the DC-DC converter 1 in the operation mode φ1s and its equivalent circuit, respectively.

In the operation mode φ1s, the third switching element SW3 and the fourth switching element SW4 are in the ON state and the first switching element SW1, the second switching element SW2, and the fifth switching element SW5 are in the OFF state. That is, when the operation mode is switched from φ1 to φ2, the control circuit 2 turns OFF the third switching element SW3 and turns ON the second switching element SW2 after turning OFF the first switching element SW1 and turning ON the fourth switching element SW4.

Thus, a current path denoted by reference numeral R1s in FIG. 14A is formed. The current path of the inductor current IL is shifted from the current path R1 of the operation mode φ1 to the current path R2 of the operation mode φ2 without causing the inductor current IL to be disconnected in the way.

In addition, as indicated by a dotted line, diodes D1 and D2 (see the dotted line) may be respectively connected between both ends of the third switching element SW3 and between both ends of the fourth switching element SW4. In this case, since the inductor current IL may flow through the diodes D1 and D2 to bypass the third switching element SW3 and the fourth switching element SW4, the operation mode φ1s may not be provided. In order to increase the switching frequency, it is desirable that the period of the operation mode φ1s is short.

Based on the equivalent circuit of the operation mode φ1s and the equivalent circuit of the operation mode φ4 (see FIG. 13B), stress voltages of the switching elements SW1 to SW5 in the operation mode φ1s may be obtained. The stress voltage of the second switching element SW2 is Vout and the stress voltage of the first switching element SW1 is Vin−Vout. Since the third switching element SW3 and the fourth switching element SW4 are in the ON state, their respective stress voltages are zero (0). In addition, the stress voltage of the fifth switching element SW5 becomes close to zero (0) by the inductor L. Thus, the stress voltages of the switching elements SW1 to SW5 becomes less than Vin.

In addition, in order to prevent the input voltage Vin and the output voltage Vout from becoming equal to each other due to the parallel connection of the input power supply E to the load LD when the operation mode is shifted from φ4 to φ1, the DC-DC converter 1 may include an operation mode φ4s between the operation modes φ4 and φ1.

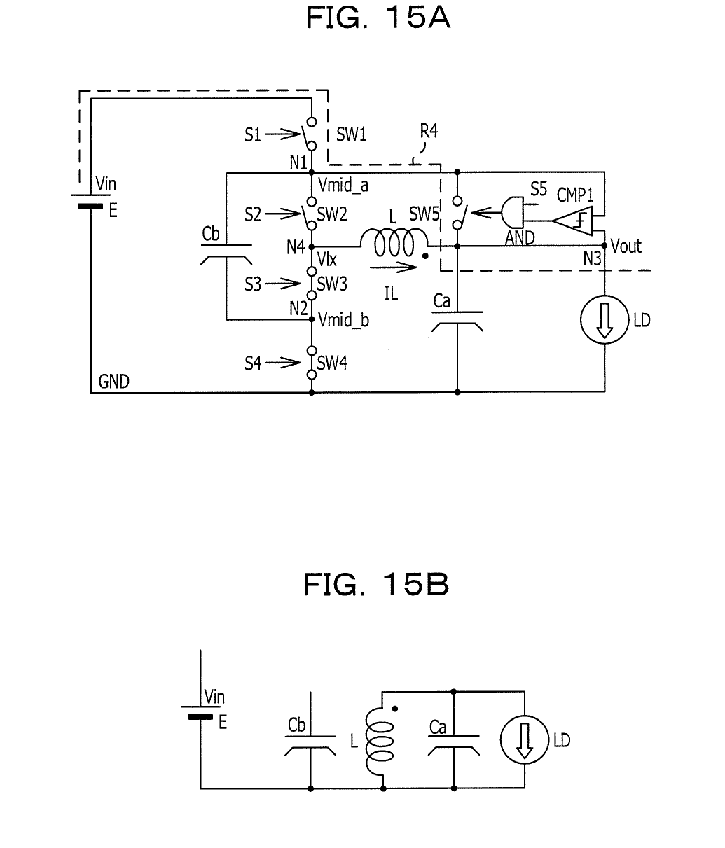

FIGS. 15A and 15B are circuit diagrams illustrating a circuit of the DC-DC converter 1 in the operation mode φ4s and its equivalent circuit, respectively. FIG. 15A illustrates the circuit of the DC-DC converter 1 and FIG. 15B illustrates the equivalent circuit thereof.

In the operation mode φ4s, the third switching element SW3 and the fourth switching element SW4 are in the ON state and the first switching element SW1, the second switching element SW2 and the fifth switching element SW5 are in the OFF state.

When the operation mode is shifted from φ4 to φ1 and the switching element SW1 is initially in the ON state, the positive terminal of the input power supply E and an output terminal N3 are short-circuited and thus, the input voltage Vin and the output voltage Vout become equal to each other, as denoted by reference numeral R4. As a result, an overvoltage is applied to the external load LD. For this reason, when the operation mode is switched from φ4 to φ1, the control circuit 2 turns ON the first switching element SW1 and turns OFF the fourth switching element SW4 after turning OFF the fifth switching element SW5.

More specifically, upon detecting decrease in the output voltage Vout, the hysteresis comparator CMP2 illustrated in FIG. 8 outputs a detection signal to the control circuit 2. In response to the detection signal, the control circuit 2 outputs a control signal S5 such that the switching element SW5 is turned OFF. In the above-described example, the control signal S5 at this time exhibits a low level. Accordingly, the logic gate AND outputs a low level signal to the switching element SW5 and thus, the switching element SW5 is turned OFF state. Thereafter, the control circuit 2 switches the operation mode to φ1. In order to increase a switching frequency, it is desirable that the period of the operation mode φ4s short.

Based on the equivalent circuit of the operation mode φ4s and the equivalent circuit of the operation mode φ4 (see FIG. 13B), stress voltages of the switching elements SW1 to SW5 in the operation mode φ4s may be obtained.

The stress voltage of the second switching element SW2 is Vout and the stress voltage of the first switching element SW1 is Vin−Vout. Since the third switching element SW3 and the fourth switching element SW4 are in the ON state, the respective stress voltages thereof are zero (0). In addition, the stress voltage of the fifth switching element SW5 becomes close to zero (0) by the inductor L. Thus, the stress voltages of the switching elements SW1 to SW5 become less than Vin.

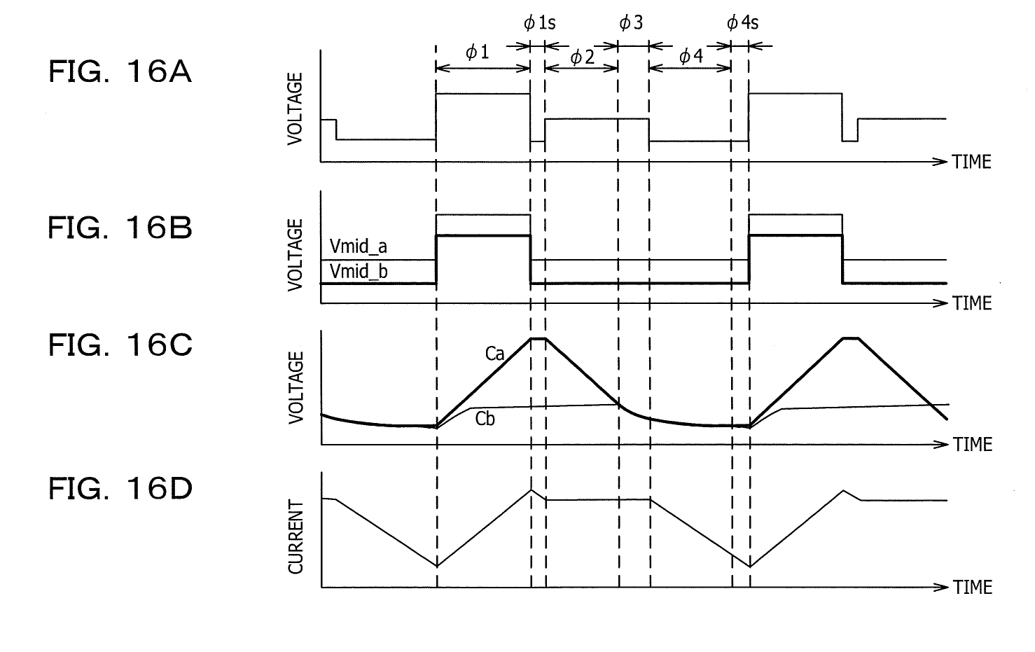

FIGS. 16A to 16D are graphs illustrating results of simulation of a current and a voltage of the DC-DC converter 1 according to the exemplary embodiment. In these figures, a vertical axis represents a current or a voltage and a horizontal axis represents time.

FIG. 16A illustrates a potential Vlx of the node N4, FIG. 16B illustrates a potential Vmid_a of the node N1 and a potential Vmid_b of the node N2, FIG. 16C illustrates a voltage Vcb of the first capacitor Cb and a voltage Vca of the second capacitor Ca (output voltage Vout), and FIG. 16D illustrates an inductor current IL. In these figures, periods of the operation modes φ1 to φ4, φ1s and φ4s are indicated on the time axis (horizontal axis).

In the operation mode 41, the first capacitor Cb and the second capacitor Ca are connected in series via the inductor L and are applied with the input voltage Vin (see FIG. 10A). Accordingly, the potential Vlx of the node N4, the potential Vmid_a of the node N1, and the potential Vmid_b of the node N2 correspond to predetermined values obtained by dividing the input voltage Vin, respectively. At this time, since the switching element SW2 is in the ON state, the node N4 and the node N2 are short-circuited to provide the same potential.

In addition, the voltages Vcb and Vca of the first capacitor Cb and the second capacitor Ca, and the inductor current IL increase with charging of the first capacitor Cb and the second capacitor Ca.

Next, in the operation mode φ1s, since the switching elements SW3 and SW4 are in the ON state, the nodes N4 and N2 are connected to the reference potential GND. Accordingly, the potential Vlx of the node N4 and the potential Vmid_b of the node N2 become the reference potential GND (0V).

The node N1 and the first capacitor Cb are separated from the input power supply E since the switching element SW1 is in the OFF state. Accordingly, the potential Vmid_a of the node N1 becomes equal to the voltage Vcb of the first capacitor Cb.

In addition, the inductor L and the second capacitor Ca are connected in parallel to the load LD (see FIG. 14). Accordingly, the inductor current IL decreases with discharging of the second capacitor Ca. On the other hand, the voltage Vca of the second capacitor Ca remains constant since one end of the second capacitor Ca is opened.

Next, in the operation mode φ2, since the switching element SW4 is in the ON state, the node N2 is connected to the reference potential GND. Accordingly, the potential Vmid_b of the node N2 remains at the reference potential GND (0V).

Since the switching element SW2 is in the ON state, the nodes N1 and N4 are short-circuited to provide the same potential. Here, since the switching element SW4 is in the ON state, the potential Vmid_a of the node N1 and the potential Vlx of the node N4 are equal to the voltage Vcb of the first capacitor Cb.

Since both ends of the inductor L are respectively connected to the reference potential GND via the first capacitor Cb and the second capacitor Ca (see, for example, FIGS. 11A and 11B), the inductor current IL flows toward the load LD without being substantially changed. The voltages Vcb and Vca of the first capacitor Cb and the second capacitor Ca decrease with discharging of the first capacitor Cb and the second capacitor Ca. At this time, since the inductor current IL flows into the second capacitor Ca as well as the load LD, an amount of decrease in the voltage Vca of the second capacitor Ca per time is smaller than an amount of decrease in the voltage Vcb of the first capacitor Cb.

Next, in the operation mode φ3, since the switching element SW4 is in the ON state, the node N2 is connected to the reference potential GND. Accordingly, the potential Vmid_b of the node N2 remains at the reference potential GND (0V).

Since the switching element SW2 is in the ON state, the nodes N1 and N4 are short-circuited to provide the same potential. Here, since the switching element SW4 is in the ON state, the potential Vmid_a of the node N1 and the potential Vlx of the node N4 are equal to the voltage Vcb of the first capacitor Cb.

Since both ends of the inductor L are short-circuited by the switching element SW5 (see FIG. 12A), the voltages Vcb and Vca of the first capacitor Cb and the second capacitor Ca are equal to each other. The voltages Vcb and Vca of the first capacitor Cb and the second capacitor Ca decrease with discharging of the first capacitor Cb and the second capacitor Ca. Accordingly, the inductor current IL flows toward the load LD without being substantially changed.

Next, in the operation mode φ4, since the switching elements SW3 and SW4 are in the ON state, the nodes N4 and N2 are connected to the reference potential GND. Accordingly, the potential Vlx of the node N4 and the potential Vmid_b of the node N2 remain at the reference potential GND (0V).

Since the switching elements SW4 and SW5 are in the ON state, the potential Vmid_a of the node N1 is equal to the voltages Vcb and Vca of the first capacitor Cb and the second capacitor Ca. Since the first capacitor Cb and the second capacitor Ca are connected in parallel to the load LD, the voltages Vcb and Vca of the first capacitor Cb and the second capacitor Ca are equal to each other and decrease with discharging of the first capacitor Cb and the second capacitor Ca.

In addition, the inductor L is connected in parallel to the load LD, together with the first capacitor Cb and the second capacitor Ca (see FIGS. 13A and 13B). Accordingly, the inductor current IL flows toward the load LD to be greatly reduced.

Next, in the operation mode φ4s, since the switching elements SW3 and SW4 are in the ON state, the nodes N4 and N2 are connected to the reference potential GND. Accordingly, the potential Vlx of the node N4 and the potential Vmid_b of the node N2 remain at the reference potential GND (0V).

Since the switching elements SW4 and SW5 are in the ON state, the potential Vmid_a of the node N1 is equal to the voltage Vcb of the first capacitor Cb. Since the first capacitor Cb is separated from the input power supply E and the load LD, the voltage Vcb of the first capacitor Cb remains constant.

In addition, the inductor L and the second capacitor Ca is connected in parallel to the load LD (see FIG. 15). Accordingly, the voltage Vca of the second capacitor Ca decreases with discharging of the second capacitor Ca and the inductor current IL flows toward the load LD to be greatly reduced.

In the above simulation, the conversion efficiency of the DC-DC converter 1 was 94.5%. Meanwhile, according to the simulation results of the third comparative example, the conversion efficiency of the DC-DC converter was 80%. Therefore, according to the DC-DC converter 1 according to the exemplary embodiment, improvement of conversion efficiency by 14.5% was accomplished.

In the above-described exemplary embodiment, when fine transistors are used for the first to fifth switching elements SW1 to SW5, it may be considered that the first switching elements SW1 to SW5 may be destroyed when the input voltage Vin is applied thereto at the time of starting-up the DC-DC converter since the withstand voltage of the fine transistors is low. Therefore, a voltage applied to the first to fifth switching elements SW1 to SW5 at the starting-up may be reduced by providing a protection circuit connected to the input power supply E.

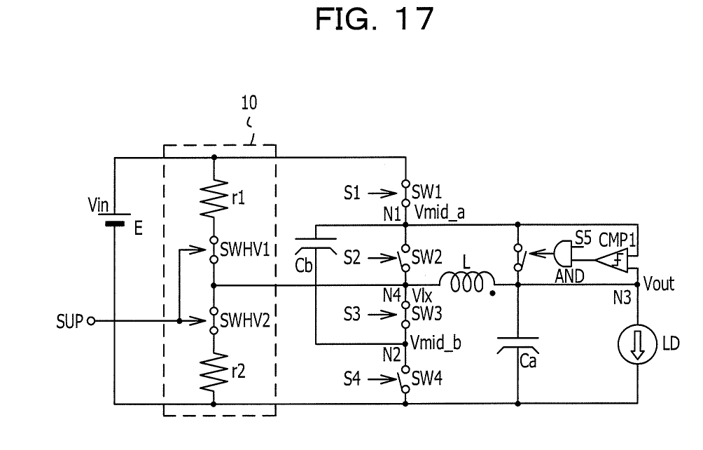

FIG. 17 is a circuit diagram illustrating a circuit of a DC-DC converter according to another exemplary embodiment. In FIG. 17, the same elements as FIG. 8 are denoted by the same reference numerals and descriptions thereof will be omitted.

A DC-DC converter 1 includes an inductor L, a first capacitor Cb, a second capacitor Ca, first to fifth switching element SW1 to SW5, a logic gate AND, a comparator (detection circuit) CMP1, and a protection circuit 10. The protection circuit 10 includes a first high-withstand voltage switching element SWHV1, a second high-withstand switching element SWHV2, a first resistor r1 and a second resistor r2.

The first resistor r1 and the second resistor r2 constitute a voltage dividing circuit for an input voltage Vin. The first resistor r1 and the second resistor r2 may have the same or different resistances.

The first high-withstand voltage switching element SWHV1 and the second high-withstand switching element SWHV2 have a higher withstand voltage than at least the first to fifth switching elements SW1 to SW5 and the respective one ends thereof are connected to each other. The one ends of the first high-withstand voltage switching element SWHV1 and the second high-withstand switching element SWHV2 are connected to a node N4. The other end of the first high-withstand voltage switching element SWHV1 is connected to a positive terminal of an input power supply E via the first resistor r1 and the other end of the second high-withstand switching element SWHV2 is connected to a negative terminal of the input power supply E via the second resistor r2.

The first high-withstand voltage switching element SWHV1 and the second high-withstand switching element SWHV2 are controlled to be switched ON/OFF by a starting-up control signal SUP input to the respective control terminals. The starting-up control signal SUP is input from, for example, a control circuit 2. The first high-withstand voltage switching element SWHV1 and the second high-withstand switching element SWHV2 remain in the ON state until starting-up of the DC-DC converter 1 is completed according to the starting-up control signal SUP. Therefore, the first to fifth switching elements SW1 to SW5 are applied with voltages obtained by dividing the input voltage Vin by the first resistor r1 and the second resistor r2 until the completion of starting-up of the DC-DC converter 1.

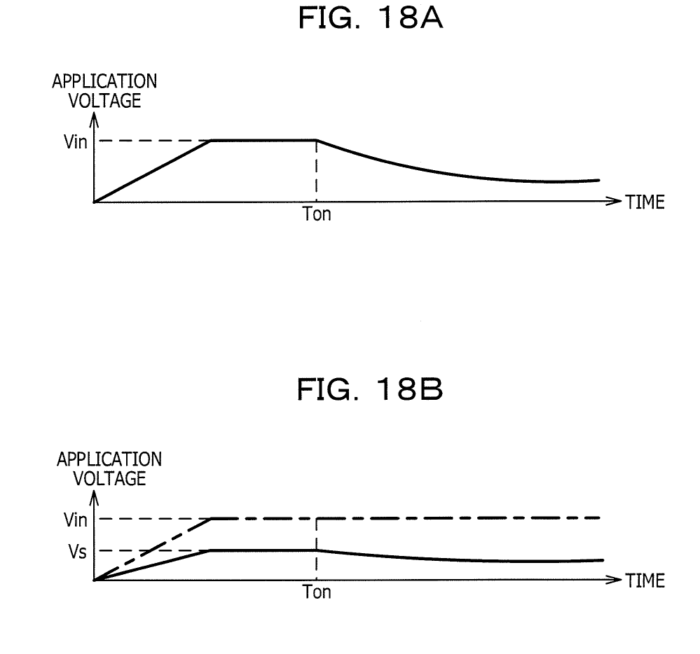

FIGS. 18A and 18B are graphs illustrating changes of application voltages of the switching elements SW1 to SW4 in a case where the protection circuit 10 is present and in a case where the protection circuit 10 is not present. FIG. 18A illustrates a change of an application voltage of the switching elements SW1 to SW4 in a case where the protection circuit 10 is not present and FIG. 18B illustrates a change of an application voltage of the switching elements SW1 to SW4 in a case where the protection circuit 10 is present. In FIGS. 18A and 18B, a horizontal axis represents time and a vertical axis represents a voltage. Time Ton represents time of starting-up completion of the DC-DC converter 1. That is, the ON/OFF control of the switching elements SW1 to SW5 is started at time Ton.

In the case where the protection circuit 10 is not present, the switching elements SW1 to SW5 are applied with the input voltage Vin until the starting-up completion time Ton. Therefore, the switching elements SW1 to SW4 are likely to be destroyed by the applied voltage exceeding a withstand voltage.

On the other hand, in the case where the protection circuit 10 is present, since the input voltage Vin is divided by the first resistor r1 and the second resistor r2 until the starting-up completion time Ton, the switching elements SW1 to SW5 are applied with a voltage Vs which is lower than the input voltage Vin. Therefore, the switching elements SW1 to SW5 will not be destroyed by the applied voltage exceeding the withstand voltage. In addition, after the starting-up completion time Ton, the application voltage of the switching elements SW1 to SW5 is slowly decreased by the above-described switching operation of the operation modes φ1 to φ4.

Thus, in the present exemplary embodiment, the input voltage Vin applied to the switching elements SW1 to SW5 is divided until the ON/OFF control of the switching elements SW1 to SW5 is started. Therefore, when the DC-DC converter is started, the switching elements SW1 to SW5 may avoid being destroyed by the application voltage which exceeds the withstand voltage.

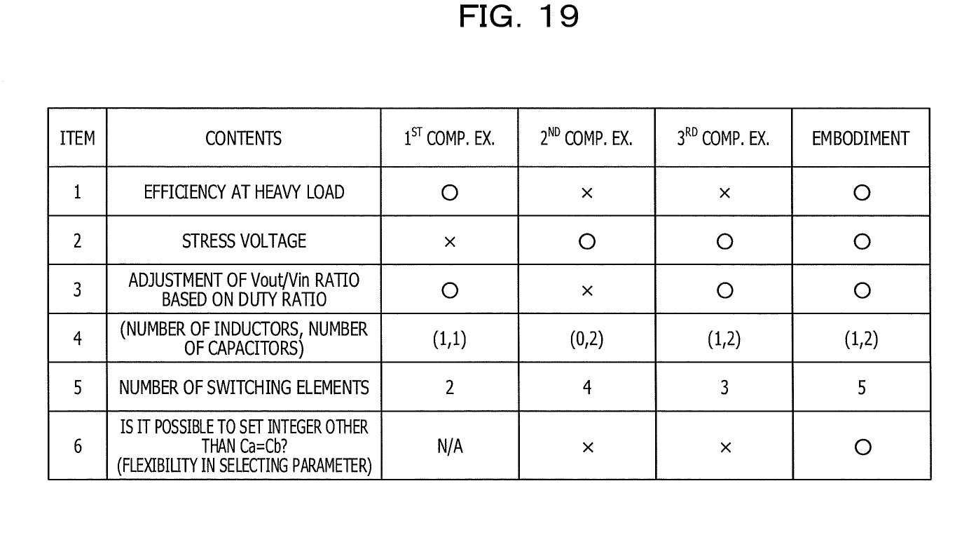

FIG. 19 illustrates the quality of performances related to the first to third comparative examples and the exemplary embodiment. As described above, since the DC-DC converter 1 according to the exemplary embodiment includes the operation modes φ2 and φ3, efficiency at a heavy load may be improved. In addition, in the DC-DC converter 1 according to the exemplary embodiment, since the stress voltages of the switching elements SW1 to SW5 are low (Vin−Vout), Vout/Vin may be controlled based on a duty ratio. Therefore, the DC-DC converter 1 according to the exemplary embodiment illustrates good performance for items 1 to 3. Items 1 to 3 for the first to third comparative examples are as described above.

FIG. 19 illustrates items 4 to 6 in addition to items 1 to 3 of FIG. 7. Item 4 is the number of inductors and the number of capacitors included in the circuit of the DC-DC converter. The number of inductors and the number of capacitors in the first comparative example are respectively 1. The number of inductors and the number of capacitors in the second comparative example are respectively 0 and 2.

On the contrary, the number of inductors and the number of capacitors in the third comparative example and the exemplary embodiment are respectively 1 and 2. Therefore, the number of inductors and the number of capacitors in the first comparative example and the exemplary embodiment are more than those in the first comparative example and the second comparative example.

Item 5 is the number of switching elements. The number of switching elements in the first comparative example is 2 and the number of switching elements in the second comparative example is 4. The number of switching elements in the third comparative example is 3 and the number of switching elements in the exemplary embodiment is 5. Therefore, the number of switching elements in the exemplary embodiment is more than those in the first to third comparative examples.

Item 6 is a result of determination on whether to set a constant other than Ca=Cb when it is assumed that the capacitances of the first capacitor Cb and the second capacitor Ca are respectively Ca and Cb. That is, item 6 represents flexibility in selecting a parameter.

As described above, in the first comparative example and the second comparative example, since a parameter is selected to be Ca=Cb in reality, the first comparative example and the second comparative example are bad in terms of performance of item 6. Meanwhile, in the exemplary embodiment, since a parameter of Ca≠Cb may be selected, the exemplary embodiment is good in terms of performance of item 6. In the first comparative example, since no capacitor is used, this item is out of application (“N/A”).

Thus, the DC-DC converter 1 according to the exemplary embodiment has more components than those of the first to third comparative examples (items 4 and 5). However, the DC-DC converter 1 according to the exemplary embodiment has advantages having good conversion efficiency (item 1), a good stress voltage (item 2), the function of adjustment of Vin/Vout (item 3) and the flexibility in selecting good parameter (item 6).

Therefore, the DC-DC converter 1 according to the exemplary embodiment may perform high frequency switching since fine transistors having low withstand voltage capability may be used for the switching elements SW1 to SW5. Accordingly, since small inductances and capacitances may be set components such as inductors and capacitors may be miniaturized.

As described above, the DC-DC converter 1 according to the exemplary embodiment includes the inductor L, the first capacitor Cb, the second capacitor Ca, the plurality of switching elements SW1 to SW5, the detection circuit (comparator) CMP1, and the control unit 20. The plurality of switching elements SW1 to SW5 is connected to the inductor L, the first capacitor Cb, and the second capacitor Ca.

The control unit 20 controls the ON/OFF switching of the plurality of switching elements SW1 to SW5 such that the connection form of the inductor L, the first capacitor Cb and the second capacitor Ca is alternately switched between the first form (operation mode φ1) and the second form (operation mode φ4).

In the first form φ1, the inductor L, the first capacitor Cb, and the second capacitor Ca are connected in series such that the first capacitor Cb and the second capacitor Ca are charged. In the second form φ4, the inductor L, the first capacitor Cb, and the second capacitor Ca are connected in parallel such that the first capacitor Cb and the second capacitor Ca are discharged.

The comparator CMP1 detects a difference between the voltage Vcb across the first capacitor Cb and the voltage Vca across the second capacitor Ca. The control unit 20 controls the ON/OFF switching of the plurality of switching elements SW1 to SW5 such that the connection form becomes the third form (operation mode φ2) before the connection form is switched from the first form to the second form and, in the third form, both ends of the inductor L are short-circuited (operation mode φ3) when the voltage difference detected by the detection circuit CMP1 is less than a predetermined value. In the third form, both ends of the inductor L is respectively connected to the reference potential via the first capacitor Cb and the second capacitor Ca.

As described above, the DC-DC converter 1 includes the third form φ2 between the first form φ1 for charging the first capacitor Cb and the second capacitor Ca and the second form φ4 for discharging the first capacitor Cb and the second capacitor Ca. In the third form φ2, the one ends of the first capacitor Cb and the second capacitor Ca are connected via the inductor L and both ends of the inductor L are short-circuited when the voltages Vcb and Vca across the first and second capacitors Cb and Ca become equal to each other. Therefore, when the connection form is switched from the first form φ1 to the second form 44, no difference occurs between the voltages Vcb and Vca across the first capacitor Cb and the second capacitor Ca.

Accordingly, since the current is prevented from flowing toward the input power supply E, power loss may be reduced. Thus, the DC-DC converter 1 according to the exemplary embodiment improves conversion efficiency.

In addition, according to an exemplary embodiment, a method of controlling the DC-DC converter including the inductor L, the first capacitor Cb and the second capacitor Ca includes the following steps (1) to (3).

<Step (1)>

The connection form of the inductor L, the first capacitor Cb, and the second capacitor Ca is switched between the first form φ1 and the second form 44. In the first form φ1, the inductor L, the first capacitor Cb, and the second capacitor Ca are connected in series such that the first capacitor Cb and the second capacitor Ca are charged. In the second form φ4, the inductor L, the first capacitor Cb, and the second capacitor Ca are connected in parallel such that the first capacitor Cb and the second capacitor Ca are discharged.

<Step (2)>

The connection form of the inductor L, the first capacitor Cb and the second capacitor Ca is set to the third form φ2 where both ends of the inductor L are respectively connected to the reference potential GND via the first capacitor Cb and the second capacitor Ca before the connection form is switched from the first form φ1 to the second form φ4.

<Step (3)>

In the third form φ2, both ends of the inductor L are short-circuited when the difference between the voltages Vcb and Vca across the first capacitor Cb and the second capacitor Ca is less than a predetermined value.

The method of controlling the DC-DC converter according to the exemplary embodiment illustrates the same acting effects as those described above, since the DC-DC converter has the same configuration as the above-described DC-DC converter 1.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the exemplary embodiments of the present invention have been described in detail, it should be understood that the various changes, substitutions, and alterations could be made hereto without departing from the spirit and scope of the invention.

What is claimed is:

1. A DC-DC converter comprising:
an inductor;
a first capacitor and a second capacitor;
a plurality of switching elements coupled to the inductor, the first capacitor, and the second capacitor;
a control circuit configured to control the plurality of switching elements to be switched ON/OFF such that a connection form of the inductor, the first capacitor, and the second capacitor is alternately switched between a first form where the inductor, the first capacitor, and the second capacitor are coupled in series such that the first capacitor and the second capacitor are charged and a second form where the inductor, the first capacitor, and the second capacitor are coupled in parallel such that the first capacitor and the second capacitor are discharged; and
a detection circuit configured to detect a difference between each of a voltage across the first capacitor and a voltage across the second capacitor,
wherein the control circuit controls an ON/OFF switching of the plurality of switching elements such that the connection form is set to a third form where both ends of the inductor are respectively coupled to a reference potential via the first capacitor and the second capacitor before the connection form is switched from the first form to the second form and, in the third form, both ends of the inductor are short-circuited when the voltage difference detected by the detection circuit becomes equal to or less than a predetermined value.

2. The DC-DC converter according to claim 1, wherein a first terminal of the inductor and a first terminal of the second capacitor are coupled to an external load, and a second terminal of the second capacitor is coupled to the reference potential,
wherein the plurality of switching elements includes:
a first switching element having one terminal coupled to an external power supply and the other terminal coupled to a first terminal of the first capacitor;
a second switching element having one terminal coupled to the first terminal of the first capacitor and the other terminal coupled to a second terminal of the inductor;
a third switching element having one terminal coupled to the second terminal of the inductor and the other terminal coupled to a second terminal of the first capacitor;
a fourth switching element having one terminal coupled to the second terminal of the first capacitor and the other terminal coupled to the reference potential; and
a fifth switching element having one terminal coupled to the first terminal of the first capacitor and the other terminal coupled to the first terminal of the inductor, and
wherein in the first form, the control circuit turns ON the first switching element and the third switching element, and turns OFF the second switching element, the fourth switching element, and the fifth switching element;
in the second form, the control circuit turns OFF the first switching element and the second switching element, and turns ON the third switching element, the fourth switching element, and the fifth switching element;
in the third form, the control circuit turns ON the second switching element and the fourth switching element, and turns OFF the first switching element, the third switching element, and the fifth switching element; and
in the third form, when the voltage difference detected by the detection circuit becomes equal to or less than the predetermined value, the fifth switching element is turned ON to short-circuit the both ends of the inductor.

3. The DC-DC converter according to claim 2, wherein, when the connection form is switched from the second form to the first form, the control circuit, turns ON the first switching element and turns OFF the fourth switching element after turning OFF the fifth switching element.

4. The DC-DC converter according to claim 2, wherein, when the connection form is switched from the first form to the third form, the control circuit turns OFF the third switching element and turns ON the second switching element after turning ON the first switching element and turning ON the fourth switching element.

5. The DC-DC converter according to claim 1, further comprising:
a voltage dividing circuit configured to divide an input voltage applied to the plurality of switching elements until the ON/OFF switching control of the plurality of switching elements is started.

6. A method of controlling a DC-DC converter including an inductor, a first capacitor, and a second capacitor, the method comprising:
alternately switching a connection form of the inductor, the first capacitor and the second capacitor between a first form where the inductor, the first capacitor and the second capacitor are coupled in series such that the first capacitor and the second capacitor are charged and a second form where the inductor, the first capacitor and the second capacitor are coupled in parallel such that the first capacitor and the second capacitor are discharged; and
setting the connection form to a third form where both ends of the inductor are respectively coupled to a reference potential via the first capacitor and the second capacitor before the connection form is switched from the first form to the second form; and
short-circuiting both ends of the inductor in the third form when a difference between a voltage across the first capacitor and a voltage across the second capacitor becomes equal to or less than a predetermined value.
